(19) United States
(12) Patent Application Publication
(10) Pub. No.: US 2018/0111641 A1
(43) Pub. Date: Apr. 26, 2018

(54) Ball Screw Drive and Motor Vehicle Steering System Equipped with Same

(71) Applicant: Robert Bosch Automotive Steering GmbH, Schwäbisch Gmünd (DE)

(72) Inventors: Oliver Hetzel, Waldstetten (DE); Michael Jueschke, Spraitbach (DE); Werner Bernhard, Mögglingen (DE)

(21) Appl. No.: 15/562,654

(22) PCT Filed: Feb. 25, 2016
(86) PCT No.: PCT/EP2016/053916

§ 371 Date: Sep. 28, 2017

(30) Foreign Application Priority Data
Mar. 31, 2015 (DE) 10 2015 104 919.8

(51) Int. Cl. B62D 5/04; F16H 25/22; F16C 17/02

(52) U.S. Cl. CPC B62D 5/0448; F16H 25/2204; B62D 3/12; F16C 17/02; B62D 5/0424

(57) ABSTRACT

A ball screw drive includes a lead screw for converting an auxiliary torque produced by an electric motor into an auxiliary translational force acting on a steering rack in a steering system of a motor vehicle. One end of the lead screw and one end of the steering rack are each connected to a track rod via an axial link, and the ball screw drive has a ball nut mounted in a housing with a fixed bearing. In order to withstand strong lateral loads or lateral forces coming from the track rod or rods and acting in the radial direction there is provided between the end of the lead screw connected to the track rod and the ball screw drive a plain bearing element which supports the lead screw radially against the housing. The support is provided by an adjustable radial clearance, and the plain bearing element is a sleeve.

The invention relates to a ball screw drive and to a steering system, equipped with said ball screw drive, of a motor vehicle. In particular, the invention relates to a ball screw drive which comprises a threaded spindle for converting an assistance torque generated by an electric motor into a translational assistance force which acts on a toothed rack in the steering system of the motor vehicle.

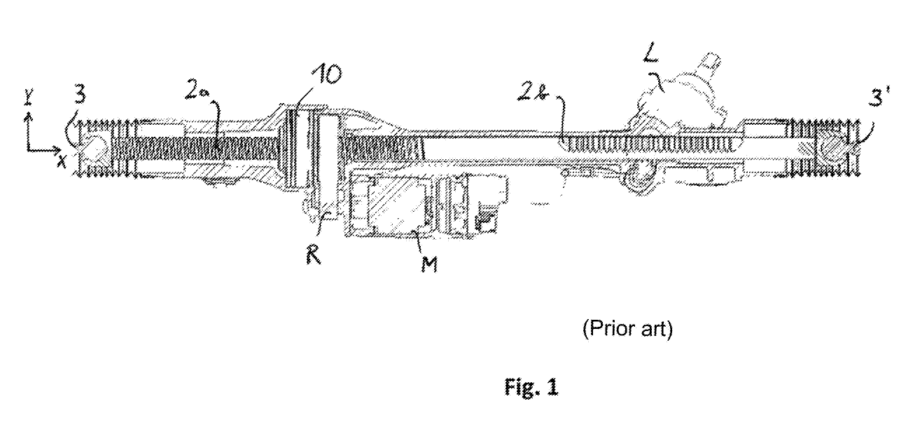

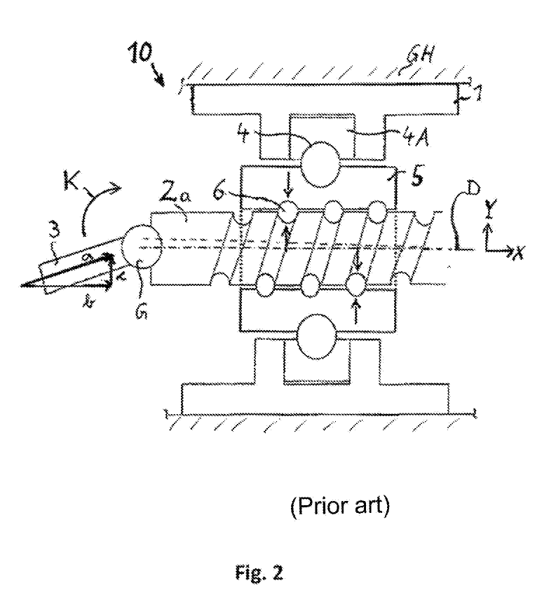

In the field of motor vehicle steering systems, it is well known to use ball screw drives for the purposes of converting a rotational assistance force (torque) generated by an assistance motor (electric motor) into a translational assistance force which acts on a threaded spindle or toothed rack of the steering system. FIG. 1 schematically illustrates such a construction. As can be seen in said figure, the threaded spindle 2a and the toothed rack 2b of the steering system are deflected by means of the ball screw drive 10, wherein the end of the threaded spindle 2a is connected by means of an axial joint G to a track rod 3; at the end of the toothed rack 2b, the latter is correspondingly connected articulatedly to a track rod 3′. The toothed rack 2b is in engagement with the pinion of a steering gear L. The ball screw drive 10 is driven by an electric motor M via a belt R or the like. FIG. 2 illustrates the construction of the ball screw drive in detail: the ball screw drive 10 has a ball nut 5 which is mounted in a housing 1 by means of a fixed bearing 4, which ball nut, together with the threaded spindle 2a and the circulating balls 6, forms the major part of the ball screw drive and can rotate about the axis of rotation D.

A ball screw drive of said type is known for example from DE 10 2012 110 081 A1. Said type of ball screw drive is commonly used in electric power steering systems, so-called EPS (Electric Power Steering) systems.

It is furthermore known, for example from DE 10 20010 029 266 A1, for a ball screw drive of the type mentioned in the introduction to be further developed such that at least one spring element “24” is arranged on each face side of the fixed bearing, in particular on the outer ring of the fixed bearing (see FIG. 2 of said document). In this way, at the fixed bearing, an elasticity of the bearing arrangement is realized, whereby shock loads acting in an axial direction can be damped in an effective manner.

FIG. 2 illustrates a conventional ball screw drive 10 in the case of which, in everyday use, the problem arises that in particular the transverse force component c of the track rod force a (generated by the given angle of the respective track rods 3 in the vehicle) poses a major challenge with regard to the assembly of a ball screw drive in an EPS system. If the steering system is not capable of accommodating such high transverse forces, damage to the ball screw drive (hereinafter also referred to as recirculating-ball screw) can arise, which leads inter alfa to a significant impairment of the acoustic characteristics. As can be seen in FIG. 2 on the basis of the graphic breakdown of the track rod force a into the components b and c, the transverse force component c of the track rod force a leads to a radial load, that is to say to a transverse load of the ball screw drive 10 acting in a radial direction Y. Said transverse load has the effect not only that the threaded spindle 2a and toothed rack 2b can bend elastically but also that a corresponding tilting moment K is generated in the ball screw drive 10. The tilting moment K in turn gives rise to a particularly high load on the first balls 6 in the screw drive and on the final balls. This is indicated in FIG. 2 by the arrows. High tilting moments are supported there in the front and rear regions of the ball circuit and generate a high Hertzian stress in the “ball-on-raceway” and “ball-on-ball” points of contact, in particular in the outer thread turns of the ball nut 5. This in turn leads to a high level of damage and a severe reduction in service life, and to deformations in the ball raceway and/or on the balls, which then results in significant acoustic impairment in the ball screw drive.

The invention is thus based on a conventional ball screw drive which comprises a threaded spindle for converting an assistance torque generated by an electric motor into a translational assistance force which acts on a toothed rack in a steering system of a motor vehicle, wherein one end of the threaded spindle and one end of the toothed rack are connected in each case by means of an axial joint to a track rod, wherein the ball screw drive has a ball nut (5) which is mounted in a housing by means of a fixed bearing.

It is an object of the present invention to considerably improve a ball screw drive of the type mentioned in the introduction such that the abovementioned disadvantages are advantageously overcome. In particular, the ball screw drive should be designed for installation in steering systems such that even high transverse loads do not lead to higher loads in the ball circuit of the ball screw drive.

The object is achieved by means of a ball screw drive having the features of claim 1. Also proposed is a steering system which is equipped with a ball screw drive of said type.

The ball screw drive according to the invention is distinguished by the fact that a plain bearing element is arranged between that end of the threaded spindle which is connected to the track rod and the ball screw drive, which plain bearing element supports the threaded spindle radially with respect to the housing.

The plain bearing element is preferably formed as a sleeve which surrounds the threaded spindle, wherein the sleeve has a conically shaped section which is of conical shape in an axial direction at its outer circumference and which bears against a conically shaped inner wall in the housing. In this way, a plain bearing can be realized which has an exactly settable radial play.

Thus, between the ball screw drive and the coupling of the track rod, there is provided a plain bearing which supports the threaded spindle radially and which can accommodate the occurring transverse forces, whereby excessively high transverse loads are prevented in an effective manner from being able to act directly on the ball circuit. Through setting of the radial play, the radial supporting effect comes to bear only if the transverse load exceeds a certain value. Thus, the normal operation of the steering system remains entirely unaffected.

In the case of high transverse loads, the occurring tilting moments are limited, such that the material loading of the components (ball nut, balls) and bending of the threaded spindle and/or toothed rack are considerably limited. In this way, it is possible to use smaller threaded spindles or toothed rack diameters, and also to provide fewer thread turns in the ball circuit, without exceeding the admissible strengths. In this way, the construction of the steering system can be realized in a very inexpensive manner. Furthermore, the entire ball chain is subjected to lower load, whereby the robustness with regard to the operating characteristics is considerably increased.

The invention relates to a steering system for a motor vehicle, which steering system is equipped with a ball screw drive of said type, and also relates to a plain bearing element per se, which is suitable for the construction of a ball screw drive of said type. In this regard, reference is also made to the coordinate claims.

The abovementioned advantages and further advantages also emerge from subclaims, which specify advantageous refinements of the invention.

It is accordingly advantageous if the plain bearing element is formed as a sleeve with a ring-shaped section with an external thread which engages with an internal thread formed in the housing. In this way, the installation position of the sleeve and thus also the clamping of the conical section can be determined in a defined manner. It is thus possible for the radial play to be set very accurately by means of the external thread.

In this context, the plain bearing element, in particular the plain bearing element formed as a sleeve, preferably has a smooth inner wall against which the outer circumference of the threaded spindle bears with a settable radial play. Here, the radial play is set by means of the installation of the plain bearing element formed as a sleeve within the housing, in particular by means of a position, set by means of the external thread, of the conically shaped section relative to the conically shaped inner wall.

The conically shaped section preferably has multiple slots which run in the axial direction, which slots divide said section into multiple segments. In this way, the conical section is provided with a certain elasticity, which yet further facilitates and improves the exact setting of the radial play. The elasticity of the conical section can be determined or adapted by means of the length of the slots.

The radial play is advantageously set such that the plain bearing element, in particular the sleeve, supports the threaded spindle radially with respect to the housing only in the event of an exceedance of a defined transverse load, in particular in the event of an exceedance of a transverse load that arises when the transverse force component amounts to more than 10%, in particular more than 20%, of the track rod force. The plain bearing thus acts as an additional floating bearing in the event of an exceedance of a certain transverse load. With the first setting (>10%), even relatively low transverse loads can be supported radially by the plain bearing. With the second setting (>20%), the radial support takes effect only in the presence of particularly high transverse loads, which arise for example in the case of exceptional events or in the case of misuse.

The conically shaped section is preferably dimensioned so as to have a gradient of between 1 and 1.5. The plain bearing element or the sleeve is preferably manufactured from metal, in particular steel or aluminum, or from plastic, in particular a polyamide.

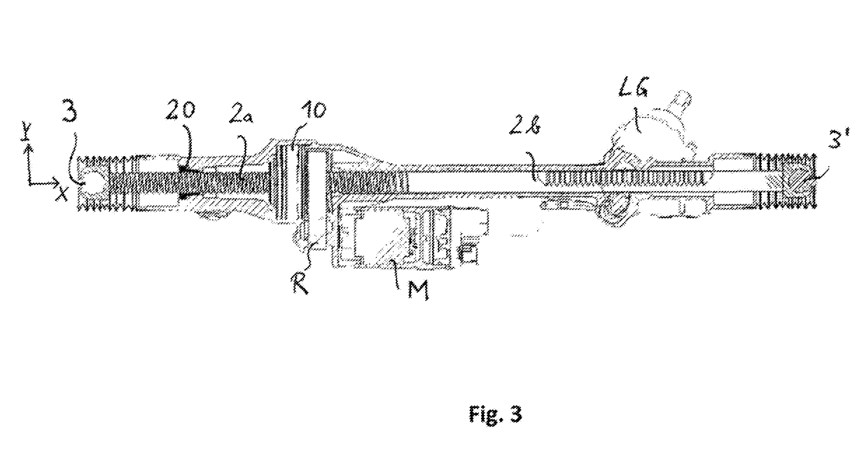

The invention will be described in detail below on the basis of exemplary embodiments which relate to a steering system for a motor vehicle and with reference to the appended drawings FIGS. 3, 4 and 5a/b, which show the following schematic illustrations:

FIG. 3 shows, in cross section, the construction of a steering system which is equipped with a ball screw drive according to the invention;

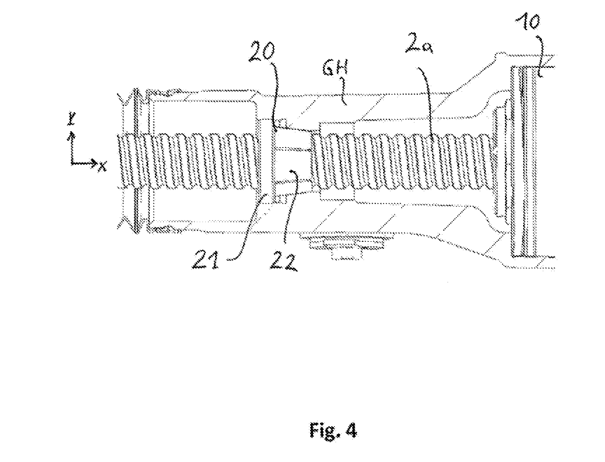

FIG. 4 shows, in greater detail, the installation of a plain bearing element in the form of a sleeve within the steering system; and

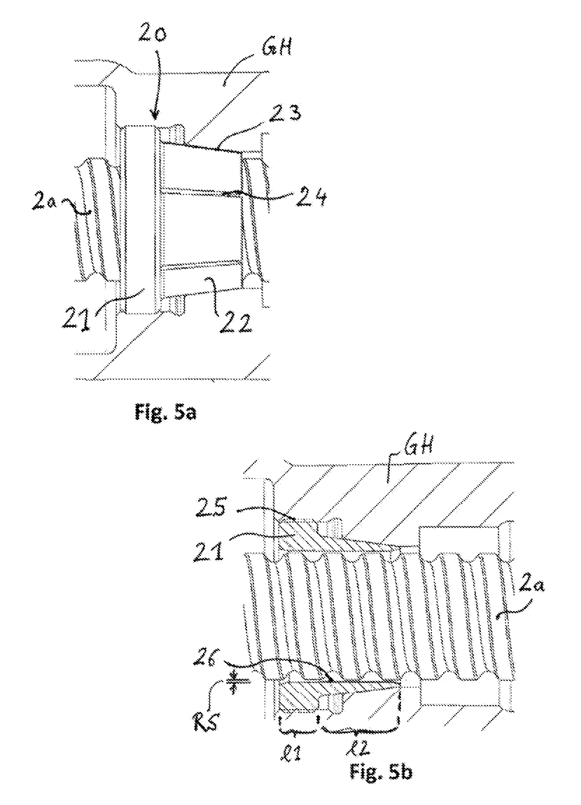

FIGS. 5a/b show further detail views illustrating the installation and construction of the plain bearing element formed as a sleeve.

The ball screw drives illustrated in FIGS. 3 and 4 also have components which are already present and denoted by reference designations in FIGS. 1 and 2. Therefore, the reference designations for the following components are maintained: steering system housing GB with steering gear LG and ball screw drive 10 in the housing (part) 1; ball nut 5; inner region or ball circuit with balls 6; threaded spindle 2b with its axis of rotation D; fixed bearing 4; toothed rack 2b; joint G for the coupling of the respective track rod 3 or 3′; belt R, and motor M.

Below, for the description of the first exemplary embodiment, reference will be made to FIGS. 3-5a/b:

FIG. 3 shows, in cross section, the construction of a steering system which is equipped with a ball screw drive according to the invention. The ball screw drive 10 comprises the threaded spindle 2a, which is formed so as to be structurally integral with the toothed rack 2b of the steering system. The collective unit will hereinafter also be referred to in simplified form as toothed rack. To the two free ends of the collective unit there is articulatedly connected a respective track rod 3 and 3′. To prevent high transverse loads, that is to say high transverse forces in the radial direction Y, overloading the ball circuit of the ball screw drive 10, a plain bearing element 20 is arranged between the ball screw drive 10 and the free end of the threaded spindle 2a, that is to say the end connected to the track rod 3, which plain bearing element supports the threaded spindle 2a radially with respect to the housing GH.

As shown in greater detail in FIGS. 4 and 5a/b, the plain bearing element is formed as a sleeve or bushing 20 which surrounds the threaded spindle 2a. The sleeve 20 has a conically shaped section 22 which is of conical shape in the axial direction x at its outer circumference and which bears against a conically shaped inner wall 23 in the housing GH. In the illustrated example, the cone of the section 22 narrows in the direction X, that is to say toward the ball nut. The sleeve 20 also has a ring-shaped section 21 which is equipped with an external thread 25 which engages with an internal thread formed in the housing GH. The sleeve 20 or the section 21 may be understood as a setting screw which, by being screwed into the internal thread of the housing GH, presses the conical section 22 with greater or lesser intensity against the conical inner wall of the housing GH. In this way, the position of the cone, or the pressing action thereof, is defined, whereby, in turn, it is determined whether, and what degree of, radial play RS exists between the smooth inner wall of the sleeve 20 and the threaded spindle 2a.

As shown in particular in FIG. 5a, the conically shaped section 22 is equipped with multiple slots 24 which run in the axial direction x, whereby said slots divide the section 22 into multiple segments. In this way, a desired elasticity of the sleeve (setting screw) 20 is determined. The material selection, for example PA6 plastic, and the dimensioning of the conical section 22 also co-determine the elasticity of the sleeve.

The radial play (RS), which is illustrated in particular on the basis of FIG. 5b, is settable during the course of the installation of the sleeve (20) by virtue of the position of the conically shaped section 22 relative to the conically shaped inner wall 23 being set to the desired dimension by means of the external thread 25. The greater the extent to which the cone is pressed against the conical inner wall of the housing GH, the smaller the radial play becomes. It can thus be achieved that a radial play always exists when no transverse load or only a small transverse load acts. Thus, the function of the ball screw drive 10 initially remains unaffected; in effect, the threaded spindle 2a freewheels within the sleeve 20.

The sleeve or setting screw is now set such that the threaded spindle 2a is supported radially with respect to the housing GH only in the event of an exceedance of a defined transverse load, that is to say it is only then that the threaded spindle bends to such an extent as to bear against the smooth inner wall 26 of the sleeve. For example, the position of the sleeve or the degree of the conical pressing action may be set such that, in the case of a transverse force component (see “c” in FIG. 2), amounts to at least 10% of the track rod force (see “a”). In this way, it is the intention for the radial play RS to be set such that the radial supporting action of the plain bearing or of the sleeve 20 takes effect only in the event of an exceedance of said value. The limit may for example also be set to at least 20%, such that the supporting action takes effect only in the presence of particularly high transverse loads, such as arise in extreme situations (exceptional events, misuse).

The setting can also be performed through the dimensioning of the gradient of the cone. It has been found that a gradient of between 1 and 1.5 is particularly advantageous here. The total length of the sleeve 20 may amount to for example approximately 15 mm. As regards the length 11 of the threaded section 21 and the length 12 of the conical section 22 (see FIG. 5b), 12 is considerably longer than 11; for example, 12 is at least 2 times as long as 11.

The installation location of the sleeve 20 is preferably situated close to the free end with the connection joint for the track rod 3. In this way, the transverse force components acting on the track rod can be better supported/accommodated. In the present example, the sleeve itself is composed of a polyamide of type PA-6, though may also be manufactured from other suitable plastics, and alternatively from metal, such as for example steel or aluminum.

The invention is particularly suitable for being installed in the steering system of a motor vehicle, in particular in a steering system with electrical power steering assistance. By means of the invention, lighter-weight design and construction variants can be realized, because smaller threaded spindles or toothed rack diameters are possible. A shorter construction of the ball nut is also possible, because fewer thread turns are required. The performance and operating characteristics are considerably improved by means of a non-braced ball chain.

In summary, the invention relates to a ball screw drive which is used in a steering system. The ball screw drive 10 comprises a threaded spindle 2a for converting an assistance torque generated by an electric motor N into a translational assistance force which acts on a toothed rack 2b in the steering system of a motor vehicle, wherein one end of the threaded spindle 2a and one end of the toothed rack 2b are connected in each case by means of an axial joint G to a track rod 3, wherein the ball screw drive 10 has a ball nut 5 which is mounted in a housing GH by means of a fixed bearing 4. In order to be able to withstand high transverse loads or transverse forces originating from the track rod(s) 3, 3′ and acting in the radial direction y, a plain bearing element 20 is arranged between that end of the threaded spindle 2a which is connected to the track rod 3 and the ball screw drive 10, which plain bearing element supports the threaded spindle 2a radially with respect to the housing GH. The support is realized by means of a settable radial play, wherein the plain bearing element is preferably formed as a sleeve 20 which surrounds the threaded spindle 2a, wherein the sleeve 20 has a conically shaped section 22 which is of conical shape in an axial direction x at its outer circumference and which bears against a conically shaped inner wall 23 in the housing GH.

### LIST OF REFERENCE DESIGNATIONS

10 Ball screw drive
1 Housing of the ball screw drive
2a Threaded spindle
2b Toothed rack
3, 3′ Track rod
4 Fixed bearing
4A Outer ring
5 Ball nut
6 Balls or ball circuit
GH Housing of the steering system
L Steering gear
D Axis of rotation
G Axial joint for the articulated connection of the track rod to the threaded spindle or toothed rack
a Track rod force (can be broken down into the components b and c)
b Axial force component
c Transverse force component
K Tilting moment
x, y, z Spatial axes or direction coordinates
R Belt
M Electric motor
20 Plain bearing in the form of a setting screw as radial support bearing for the threaded spindle
21 Ring-shaped section of the sleeve with external thread
22 Conical sections/segments
23 Conical inner wall of the housing GH
24 Slots
25 External thread
26 Inner wall of the sleeve
RS Radial play (settable)

1. A ball screw drive comprising:
a threaded spindle configured to convert an assistance torque generated by an electric motor into a translational assistance force which acts on a toothed rack in a steering system of a motor vehicle, one end of the threaded spindle and one end of the toothed rack connected in each case by an axial joint to a track rod;
a ball nut mounted in a housing by a fixed bearing; and
a plain bearing element arranged between the one end of the threaded spindle connected to the track rod and the toothed rack, the plain bearing element configured to support the threaded spindle radially with respect to the housing the plain bearing element including
a sleeve surrounding the threaded spindle the sleeve having a conically shaped section which is of conical shape in an axial direction at an outer circumference of the conically shaped section, the conically shaped section bearing against a conically shaped inner wall in the housing, the sleeve having a smooth inner wall against which an outer circumference of the threaded spindle bears with a settable radial play,
wherein the settable radial play is settable by a position, of the conically shaped section relative to the conically shaped inner wall, and
wherein the position of the conically shaped section is set by an external thread of the sleeve.

2. The ball screw drive as claimed in claim 1, wherein:
the sleeve has a ring-shaped section including the external thread, and
the external thread engages an internal thread formed in the housing.

3. The ball screw drive as claimed in claim 1 or 2, wherein the conically shaped section has multiple slots which run in the axial direction and which divide the conically shaped section into multiple segments.

4. The ball screw drive as claimed in claim 1, wherein the radial play is set such that the sleeve supports the threaded spindle radially with respect to the housing only in the event of an exceedance of a defined transverse load.

5. The ball screw drive as claimed in claim 1, 2, or 4, wherein the conically shaped section has a gradient of between 1 and 1.5.

6. The ball screw drive as claimed in claim 1, 2, or 4, wherein the sleeve is manufactured from metal.

7. A steering system with electrical power steering assistance for a motor vehicle comprising:
a track rod;
a toothed rack;
an electric motor; and
a ball screw drive including
a threaded spindle configured to convert an assistance torque generated by the electric motor into a translational assistance force which acts on the toothed rack, one end of the threaded spindle and one end of the toothed rack connected in each case by an axial joint to the track rod,
a ball nut mounted in a housing by a fixed bearing, and
a plain bearing element arranged between the one end of the threaded spindle connected to the track rod and the toothed rack, the plain bearing element configured to support the threaded spindle radially with respect to the housing, the plain bearing element including
a sleeve surrounding the threaded spindle, the sleeve having a conically shaped section which is of conical shape in an axial direction at an outer circumference of the conically shaped section, the conically shaped section bearing against a conically shaped inner wall in the housing, the sleeve having a smooth inner wall against which an outer circumference of the threaded spindle bears with a settable radial play,
wherein the settable radial play is settable by a position of the conically shaped section relative to the conically shaped inner wall, and
wherein the position of the conically shaped section is set by an external thread of the sleeve.

8. A plain bearing element for a ball screw drive including a threaded spindle, the plain bearing element comprising:
a housing; and
a sleeve surrounding the threaded spindle, the sleeve having a conically shaped section which is of conical shape in an axial direction at an outer circumference of the conically shaped section, the conically shaped section bearing against a conically shaped inner wall in the housing, the sleeve having a smooth inner wall against which an outer circumference of the threaded spindle bears with a settable radial play,
wherein the settable radial play is settable by a position of the conically shaped section relative to the conically shaped inner wall, and
wherein the position of the conically shaped section is set by an external thread of the sleeve.

9. (canceled)

10. (canceled)

11. (canceled)

12. The ball screw drive as claimed in claim 1, wherein the radial play is set such that the sleeve supports the threaded spindle radially with respect to the housing only in the event of an exceedance of a transverse load that arises when a transverse force component amounts to more than 10% of a track rod force.

13. The ball screw drive as claimed in claim 1, wherein the sleeve is manufactured from a plastic.

14. The ball screw drive as claimed in claim 13, wherein the plastic is a polyamide.
